(19) United States
(12) Patent Application Publication
(10) Pub. No.: US 2008/0231823 A1
(43) Pub. Date: Sep. 25, 2008

(54) Apparatus and methods for reducing the escape of immersion liquid from immersion lithography apparatus

(75) Inventors: Alex Ka Tim Poon, San Ramon, CA (US); Leonard Wai Fung Kho, San Francisco, CA (US); Gaurav Keswani, Fremont, CA (US); Derek Coon, Redwood City, CA (US); Yasufumi Nishii, Kumagaya-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/076,501

(22) Filed: Mar. 19, 2008

Related U.S. Application Data
(60) Provisional application No. 60/907,184, filed on Mar. 23, 2007.

(51) Int. Cl. G03B 27/52

(52) U.S. Cl. 355/30

(57) ABSTRACT

A stage assembly includes a workpiece table that supports the workpiece adjacent to an optical assembly. An environmental system supplies and removes immersion liquid to and from a space between the workpiece and the optical assembly to form an immersion area. The environmental system has a lower surface disposed opposite from an upper surface of the workpiece and/or the workpiece table. The lower surface is spaced a first distance from the workpiece and/or the workpiece table to form a meniscus at a periphery of the immersion area. An edge member is provided on the environmental system and extends past the lower surface of the environmental system so that a lower portion of the edge member is spaced a second distance, smaller than the first distance, from the upper surface of the workpiece and/or the workpiece table at a position beyond the periphery of the immersion area.

This application claims the benefit of U.S. Provisional Application No. 60/907,184 filed Mar. 23, 2007. The disclosure of the provisional application is incorporated herein by reference in its entirety.

### BACKGROUND

The invention relates to immersion lithography apparatus and methods, and particularly to apparatus and methods for reducing the escape of immersion liquid from an immersion area of immersion lithography apparatus.

A typical lithography apparatus includes a radiation source, a projection optical system and a substrate stage to support and move a substrate to be imaged. A radiation-sensitive material, such as a resist, is coated onto the substrate surface before the substrate is placed on the substrate stage. During operation, radiation energy from the radiation source is used to project an image defined by an imaging element through the projection optical system onto the substrate. The projection optical system typically includes a plurality of lenses. The lens or optical element closest to the substrate can be referred to as the last or final optical element.

The projection area during exposure is typically much smaller than the imaging surface of the substrate. The substrate therefore is moved relative to the projection optical system in order to pattern the entire surface of the substrate. In the semiconductor industry two types of lithography apparatus are commonly used. With so-called “step-and-repeat” apparatus, the entire image pattern is projected at one moment in a single exposure onto a target area of the substrate. After the exposure, the substrate is moved or “stepped” in the X and/or Y direction(s) and a new target area is exposed. This step-and-repeat process is performed multiple times until the entire substrate surface is exposed. With scanning type lithography apparatus, the target area is exposed in a continuous or “scanning” motion. For example, when the image is projected by transmitting light through a reticle or mask, the reticle or mask is moved in one direction while the substrate is moved in either the same or the opposite direction during exposure of one target area. The substrate is then moved in the X and/or Y direction(s) to the next scanned target area. The process is repeated until all of the desired target areas on the substrate have been exposed.

Lithography apparatus are typically used to image or pattern semiconductor wafers and flat panel displays. The word “substrate” or “workpiece” as used herein is intended to generically mean any workpiece that can be patterned including, but not limited to, semiconductor wafers and flat panel displays.

Immersion lithography is a technique that can enhance the resolution of lithography exposure apparatus by permitting exposure to take place with a numerical aperture (NA) that is greater than the NA that can be achieved in conventional “dry” lithography exposure apparatus. By filling the space between the final optical element of the projection system and the resist-coated substrate, immersion lithography permits exposure with light that would otherwise be internally reflected at the optic-air interface. Numerical apertures as high as the index of the immersion fluid (or of the resist or lens material, whichever is least) are possible in immersion lithography systems. Liquid immersion also increases the substrate depth-of-focus, that is, the tolerable error in the vertical position of the substrate, by the index of the immersion fluid compared to a dry system having the same numerical aperture. Immersion lithography thus can provide resolution enhancement equivalent to a shift from 248 nm to 193 nm without actually decreasing the exposure light wavelength. Thus, unlike a shift in the exposure light wavelength, the use of immersion would not require the development of new light sources, optical materials (for the illumination and projection systems) or coatings, and can allow the use of the same or similar resists as conventional “dry” lithography at the same wavelength. In an immersion system in which only the final optical element of the projection system and its housing and the substrate (and perhaps portions of the stage as well) are in contact with the immersion fluid, much of the technology and design developed for dry lithography can carry over directly to immersion lithography.

However, because the substrate moves rapidly in a typical lithography system, the immersion fluid in a space including a gap between the projection system and the substrate tends to be carried away from the space. If the immersion fluid escapes from the space, that fluid can interfere with operation of other components of the lithography system. One way to recover the immersion fluid and prevent the immersion fluid from contaminating the immersion lithography system is described in U.S. 2006/0152697 A1, the disclosure of which is incorporated herein by reference in its entirety. U.S. 2006/0152697 A1 discloses an immersion fluid supply and recovery system in which a porous member surrounds the space and is in fluid communication with the space that defines the immersion area. The porous member is maintained at a pressure that is under the bubble point of the porous member, such that immersion fluid that escapes from the space is captured (recovered) by the porous member. The porous member encircles the space and is maintained at a substantially constant low pressure.

Another problem that exists in immersion lithography apparatus is the undesired flow of the immersion liquid escaping to the under-surface of the substrate that is being exposed. Immersion liquid that was not recovered from the substrate can move to the edge of the substrate, for example, due to movement of the substrate by the substrate stage, and then flow to the under-surface of the substrate. Moreover, even with systems in which a localized area is provided with immersion liquid, such as the systems described in the above-identified U.S. 2006/0152697 A1, the localized immersion area extends beyond the periphery of the substrate when exposure takes place near the edge of the substrate. It is known to make the portion of the substrate stage surrounding the periphery of the substrate substantially flush with the upper surface of the substrate and to dispose the surrounding stage portion very close to the substrate periphery in order to inhibit the flow of immersion liquid over the substrate periphery and to the under-surface of the substrate. However, it is not uncommon for some immersion liquid to flow or wick (that is move by capillary action) through the small gap between the substrate periphery and the surrounding portion of the substrate stage, and thus wet the under-surface of the substrate.

It is undesirable to wet the under-surface of the substrate because that may cause the substrate to stick to the substrate holding member, making it difficult to remove the substrate from the substrate holding member when exposure is completed. Additionally, immersion liquid that flows to the under-surface of the substrate can enter the vacuum passages that are used to hold the substrate to the substrate holding member, which is not desirable. Other undesirable effects of the immersion liquid escaping the immersion area include liquid damage to motors that move the substrate, and liquid interfering with substrate stage position sensors, which could cause a system crash.

### SUMMARY

Aspects of the apparatus and methods described herein reduce the escape of immersion liquid from a space of immersion lithography apparatus.

Apparatus include an optical assembly that projects an image onto a workpiece, and a stage assembly including a workpiece table that supports the workpiece adjacent to the optical assembly. An environmental system supplies and removes immersion liquid to and from a space between the workpiece and the optical assembly to form an immersion area through which the image is projected onto the workpiece. The environmental system has a lower surface disposed opposite from an upper surface of the workpiece, the workpiece table, or both. The lower surface is spaced a first distance from the workpiece, the workpiece table, or both, to form a meniscus at a periphery of the immersion area. An edge member is provided on the environmental system and extends past the lower surface of the environmental system so that a lower portion of the edge member is spaced a second distance, smaller than the first distance, from the upper surface of the workpiece, the workpiece table, or both, at a position beyond the periphery of the immersion area. The edge member assists in preventing or minimizing the escape of immersion liquid from the environmental system.

According to some embodiments, at least a portion of the edge member is hydrophobic. In other embodiments, at least a portion of the edge member is hydrophilic.

According to some embodiments, the lower surface of the environmental system includes a porous member, and the edge member guides to the porous member immersion liquid escaping from the immersion area.

According to further embodiments, the edge member is mounted adjacent a liquid recovery element of the environmental system.

According to further embodiments, the environmental system includes a recess disposed at an outer periphery of the liquid recovery element to receive the immersion liquid guided from the edge member.

According to some embodiments, a vacuum is applied to the porous member to remove the immersion liquid from the porous member.

According to some embodiments, the edge member is movably attached to the environmental system.

According to some embodiments, the edge member is pivotally attached to the environmental system.

According to some embodiments, the edge member is flexible.

According to some embodiments, the edge member is annular and surrounds the immersion area.

Methods include supplying and removing immersion liquid with an environmental system to and from a space between a workpiece and an optical assembly to form an immersion area, the environmental system having a lower surface disposed opposite from an upper surface of the workpiece, the workpiece table, or both, the lower surface spaced a first distance from the workpiece, the workpiece table, or both, to form a meniscus at a periphery of the immersion area; and inhibiting escape of immersion liquid from the environmental system by providing an edge member that extends past the lower surface of the environmental system, so that a lower portion of the edge member is spaced a second distance, smaller than the first distance, from the upper surface of the workpiece, the workpiece table, or both, at a position beyond the periphery of the immersion area.

### BRIEF DESCRIPTION OF THE DRAWINGS

The invention will be described in conjunction with the following drawings of exemplary embodiments in which like reference numerals designate like elements, and in which:

FIG. 1 is an illustration of an immersion lithography apparatus to which an embodiment of the invention is applied;

FIG. 2 is a cross section of an immersion lithography apparatus according to one embodiment;

FIG. 3 illustrates further details of the immersion lithography apparatus according to the embodiment of FIG. 2;

FIG. 4 is a flow chart that outlines a process for manufacturing a device in accordance with some embodiments of the invention; and

FIG. 5 is a flow chart that outlines device processing in more detail.

### DETAILED DESCRIPTION OF EMBODIMENTS

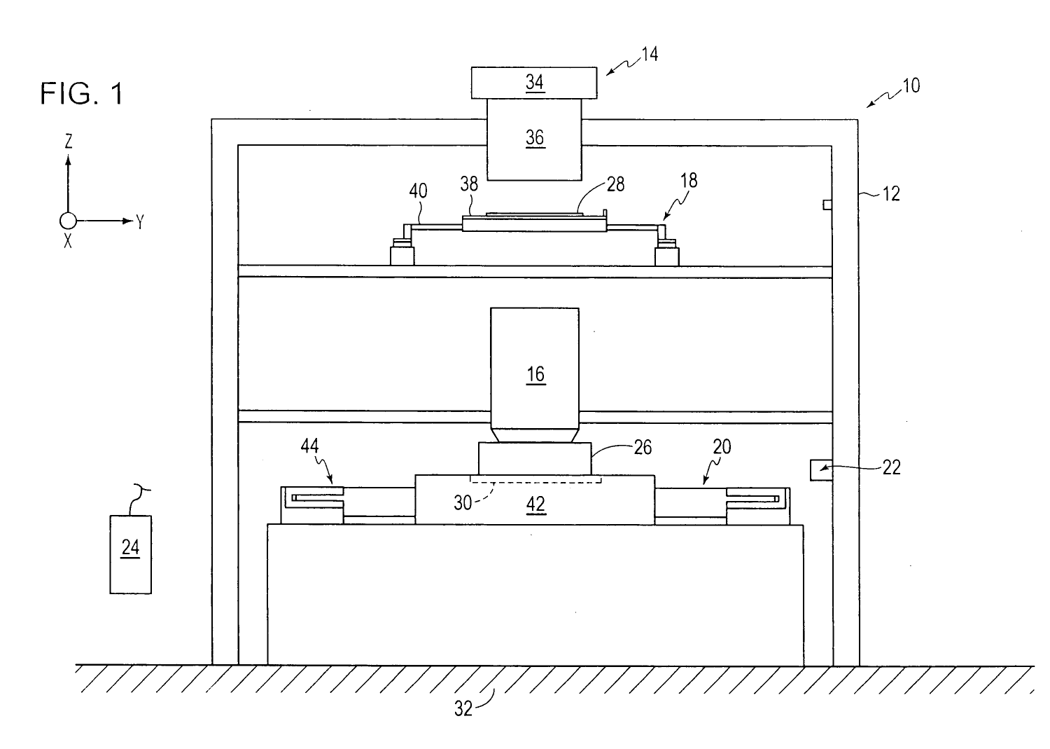

FIG. 1 is a schematic illustration of a lithography apparatus 10. The lithography apparatus 10 includes a frame 12, an illumination system 14 (irradiation apparatus), an optical assembly 16 (projection optical system), a reticle stage assembly 18, a workpiece stage assembly 20, a measurement system 22, a control system 24, and an environmental system 26. The design of the components of the lithography apparatus 10 can be varied to suit the design requirements of the lithography apparatus 10.

In one embodiment, the lithography apparatus 10 is used to transfer a pattern (not shown) of an integrated circuit from a reticle 28 onto a workpiece 30 (illustrated in phantom). The lithography apparatus 10 mounts to a mounting base 32, e.g., the ground, a base, or floor or some other supporting structure.

In various embodiments, the lithography apparatus 10 can be used as a scanning type photolithography system that exposes the pattern from the reticle 28 onto the workpiece 30 with the reticle 28 and the workpiece 30 moving synchronously. In a scanning type lithographic apparatus, the reticle 28 is moved perpendicularly to an optical axis of the optical assembly 16 by the reticle stage assembly 18, and the workpiece 30 is moved perpendicularly to the optical axis of the optical assembly 16 by the workpiece stage assembly 20. Exposure occurs while the reticle 28 and the workpiece 30 are moving synchronously.

Alternatively, the lithography apparatus 10 can be a step-and-repeat type photolithography system that performs exposure while the reticle 28 and the workpiece 30 are stationary. In the step and repeat process, the workpiece 30 is in a constant position relative to the reticle 28 and the optical assembly 16 during the exposure of an individual field. Subsequently, between consecutive exposure steps, the workpiece 30 is consecutively moved with the workpiece stage assembly 20 perpendicularly to the optical axis of the optical assembly 16 so that the next field of the workpiece 30 is brought into position relative to the optical assembly 16 and the reticle 28 for exposure. Following this process, the image on the reticle 28 is sequentially exposed onto the fields of the workpiece 30.

The use of the lithography apparatus 10 provided herein is not necessarily limited to a photolithography for semiconductor manufacturing. The lithography apparatus 10, for example, can be used as an LCD photolithography system that exposes a liquid crystal display substrate pattern onto a rectangular glass plate or a photolithography system for manufacturing a thin film magnetic head. Accordingly, the term “workpiece” is generically used herein to refer to any device that may be patterned using lithography, such as but not limited to wafers or LCD substrates.

The apparatus frame 12 supports the components of the lithography apparatus 10. The apparatus frame 12 illustrated in FIG. 1 supports the reticle stage assembly 18, the workpiece stage assembly 20, the optical assembly 16 and the illumination system 14 above the mounting base 32.

The illumination system 14 includes an illumination source 34 and an illumination optical assembly 36. The illumination source 34 emits a beam (irradiation) of light energy. The illumination optical assembly 36 guides the beam of light energy from the illumination source 34 to the optical assembly 16. The beam illuminates selectively different portions of the reticle 28 and exposes the workpiece 30. In FIG. 1, the illumination source 34 is illustrated as being supported above the reticle stage assembly 18. Typically, however, the illumination source 34 is secured to one of the sides of the apparatus frame 12, or is disposed at a remote location, and the energy beam from the illumination source 34 is directed to above the reticle stage assembly 18 with the illumination optical assembly 36.

The illumination source 34 can be, for example, a g-line source (436 nm), an i-line source (365 nm), a KrF excimer laser (248 nm), an ArF excimer laser (193 nm) or a F₂ laser (157 nm). Alternatively, the illumination source 34 can generate an x-ray.

The optical assembly 16 projects and/or focuses the light passing through the reticle 28 to the workpiece 30. Depending upon the design of the lithography apparatus 10, the optical assembly 16 can magnify or reduce the image illuminated on the reticle 28. The optical assembly 16 need not be limited to a reduction system. It also could be a 1× or greater magnification system.

Also, with an exposure substrate that employs vacuum ultraviolet radiation (VUV) of wavelength 200 nm or lower, use of a catadioptric type optical system can be considered. Examples of a catadioptric type of optical system are disclosed in U.S. Pat. No. 5,668,672, as well as U.S. Pat. No. 5,835,275. In these cases, the reflecting optical system can be a catadioptric optical system incorporating a beam splitter and concave mirror. U.S. Pat. No. 5,689,377 also uses a reflecting-refracting type of optical system incorporating a concave mirror, etc., but without a beam splitter, and also can be employed with this embodiment. The disclosures of the above-mentioned U.S. patents are incorporated herein by reference in their entireties.

The reticle stage assembly 18 holds and positions the reticle 28 relative to the optical assembly 16 and the workpiece 30. In one embodiment, the reticle stage assembly 18 includes a reticle stage 38 that retains the reticle 28 and a reticle stage mover assembly 40 that moves and positions the reticle stage 38 and reticle 28.

Each stage mover assembly 40, 44 (44 being for the workpiece 30) can move the respective stage 38, 42 with three degrees of freedom, less than three degrees of freedom, or more than three degrees of freedom. For example, in alternative embodiments, each stage mover assembly 40, 44 can move the respective stage 38, 42 with one, two, three, four, five or six degrees of freedom. The reticle stage mover assembly 40 and the workpiece stage mover assembly 44 can each include one or more movers, such as rotary motors, voice coil motors, linear motors utilizing a Lorentz force to generate drive force, electromagnetic movers, planar motors, or other force movers.

In photolithography systems, when linear motors (see U.S. Pat. Nos. 5,623,853 or 5,528,118 which are incorporated by reference herein in their entireties) are used in the wafer stage assembly or the reticle stage assembly, the linear motors can be either an air levitation type employing air bearings or a magnetic levitation type using Lorentz force or reactance force. Additionally, the stage could move along a guide, or it could be a guideless type stage that uses no guide.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage base and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100. Additionally, reaction forces generated by the reticle (mask) stage motion can be mechanically transferred to the floor (ground) by use of a frame member as described in U.S. Pat. No. 5,874,820. The disclosures of U.S. Pat. Nos. 5,528,100 and 5,874,820 are incorporated herein by reference in their entireties.

The measurement system 22 monitors movement of the reticle 28 and the workpiece 30 relative to the optical assembly 16 or some other reference. With this information, the control system 24 can control the reticle stage assembly 18 to precisely position the reticle 28 and the workpiece stage assembly 20 to precisely position the workpiece 30. The design of the measurement system 22 can vary. For example, the measurement system 22 can utilize multiple laser interferometers, encoders, mirrors, and/or other measuring devices.

The control system 24 receives information from the measurement system 22 and controls the stage assemblies 18, 20 to precisely position the reticle 28 and the workpiece 30. Additionally, the control system 24 can control the operation of the components of the environmental system 26. The control system 24 can include one or more processors and circuits.

The environmental system 26 controls the environment in a space (not shown in FIG. 1) including a gap between the optical assembly 16 and the workpiece 30. The space includes an imaging field. The imaging field includes the area adjacent to the region of the workpiece 30 that is being exposed and the area in which the beam of light energy travels between the optical assembly 16 and the workpiece 30. With this design, the environmental system 26 can control the environment in the imaging field. The desired environment created and/or controlled in the space by the environmental system 26 can vary accordingly to the workpiece 30 and the design of the rest of the components of the lithography apparatus 10, including the illumination system 14. For example, the desired controlled environment can be a liquid such as water. In various embodiments, the space may range from 0.1 mm to 10 mm in height between top surface of the workpiece 30 and the last optical element of the optical assembly 16.

In one embodiment, the environmental system 26 fills the imaging field and the rest of the space with an immersion fluid. The design of the environmental system 26 and the components of the environmental system 26 can be varied. In different embodiments, the environmental system 26 delivers and/or injects immersion fluid into the space using spray nozzles, electro-kinetic sponges, porous materials, etc. and removes the fluid from the space using vacuum pumps, sponges, and the like. The environmental system 26 confines the immersion fluid in the space below the optical assembly 16. The environmental system 26 forms part of the boundary of the space including a gap between the optical assembly 16 and one or more objects, for example the workpiece 30, the workpiece stage assembly 20, or both. The immersion fluid confined by the environmental system 26 covers a localized area on a surface of the workpiece 30, the workpiece stage assembly 20, or both. The design of the environmental system 26 can vary. For example, the environmental system 26 can inject the immersion fluid at one or more locations at or near the space. Further, the environmental system 26 can assist in removing and/or scavenging the immersion fluid at one or more locations at or near the workpiece 30, the space and/or the edge of the optical assembly 16. For additional details on various environmental systems, see, for example, U.S. 2007/0046910 A1, U.S. 2006/0152697 A1, U.S. 2006/0023182 A1 and U.S. 2006/0023184 A1, the disclosures of which are incorporated herein by reference in their entireties.

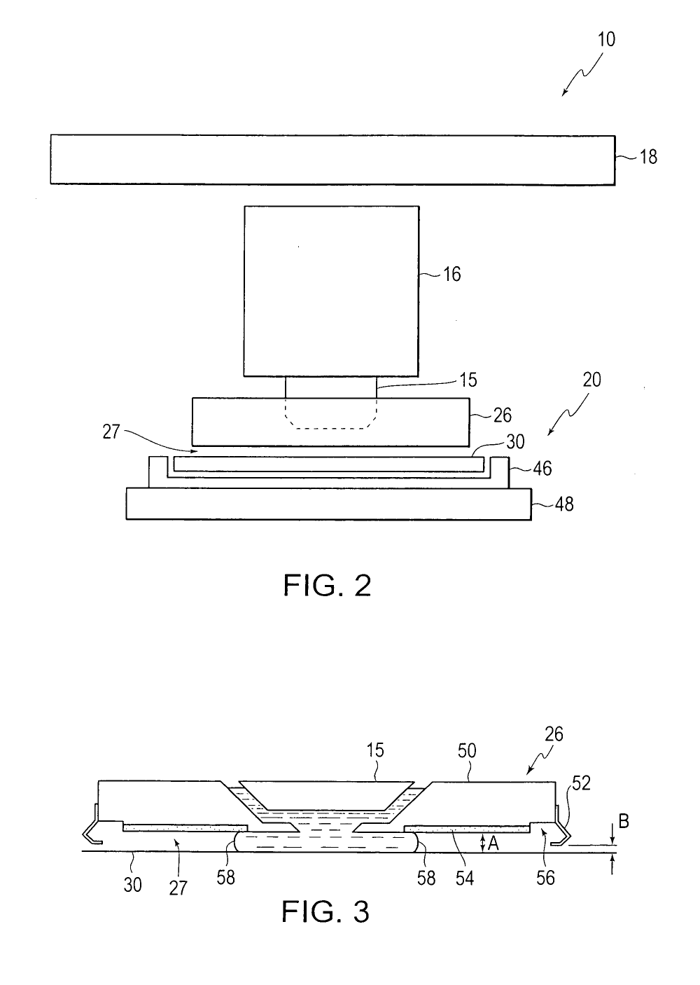

FIG. 2 shows a cross-section of the immersion lithography apparatus 10 including the reticle stage assembly 18 on which a reticle is supported, a projection system 16 having the optical element 15 (sometimes referred to as a last or “final” optical element), and the workpiece 30 supported on a workpiece table 46, which in turn is provided on a workpiece stage 48. The workpiece table 46 and the workpiece stage 48 are collectively referred to as workpiece stage assembly 20. In the embodiment, the workpiece table 46 is a fine-movement stage, and the workpiece stage 48 is a coarse-movement stage. That is, the workpiece table 46 (fine-movement stage) is movable with respect to the workpiece stage 48 (coarse-movement stage). The workpiece 30 may be vacuum chucked to the workpiece table 46 by use of a pin chuck or workpiece chuck. The environmental system 26 is disposed around the last optical element 15 of the projection system 16 so as to provide an immersion fluid, which may be a liquid such as, for example, water, to a space 27 including the gap between the last optical element 15 and the workpiece 30. In the present embodiment, the immersion lithography apparatus 10 is a scanning lithography apparatus in which the reticle 28 and the workpiece 30 are moved synchronously in respective scanning directions during a scanning exposure operation. The workpiece table 46 (fine-movement stage) controls the position of the workpiece 30 in one or more (preferably all) of the X, Y, Z, θX, θY and θZ directions with a higher degree of precision than the workpiece stage 48 (coarse-movement stage), which is primarily used for moving the workpiece 30 over longer distances, as is well known in the art.

The illumination source of the lithography apparatus can be a light source such as, for example, a mercury g-line source (436 nm) or i-line source (365 nm), a KrF excimer laser (248 nm), an ArF excimer laser (193 nm) or a F₂ laser (157 nm). The projection system 16 projects and/or focuses the light passing through the reticle 28 onto the workpiece 30. Depending upon the design of the exposure apparatus, the projection system 16 can magnify or reduce the image illuminated on the reticle. It also could be a 1× magnification system.

When far ultraviolet radiation such as from the excimer laser is used, glass materials such as quartz and fluorite that transmit far ultraviolet rays can be used in the projection system 16. The projection system 16 can be a catadioptric, completely refractive or completely reflective.

FIG. 3 shows further details of the immersion lithography apparatus according to the embodiment of FIG. 2. As shown in FIG. 3, the environmental system 26 includes an immersion fluid supply and recovery apparatus 50 which is sometimes referred to as an immersion fluid supply and recovery nozzle. The immersion fluid supply and recovery apparatus 50 is disposed around the last optical element 15 of the projection system 16 so as to provide and recover an immersion fluid, which may be a liquid such as, for example, water, to and from the space 27 under the last optical element 15 and the immersion fluid supply system and recovery apparatus 50. The area where the immersion liquid is supplied can be referred to as an immersion area. The immersion area is formed in at least a part of the space 27. The immersion area has a size that is smaller than the upper surface of the workpiece 30, and thus can be referred to as a localized area. The immersion fluid supply and recovery apparatus 50 also collects immersion liquid so that the immersion liquid is continuously (or substantially continuously) supplied to and recovered from the space 27 so as to provide a flow of fresh immersion liquid to the space 27. The immersion liquid is precisely temperature-controlled and filtered so as to remove particles and gas bubbles. Various structures can be provided as the immersion fluid supply and recovery apparatus 50. See, for example, U.S. 2005/0219488 A1, U.S. 2006/0023181 A1 and U.S. 2006/0038968 A1, the disclosures of which are incorporated herein by reference in their entireties.

As shown in FIG. 3, the immersion fluid supply and recovery apparatus 50 has a lower surface disposed opposite from an upper surface of the workpiece 30 and is spaced at a distance A from the workpiece 30. The lower surface also may be disposed opposite from an upper surface of the workpiece table 46 and is spaced at a distance A from that upper surface of the workpiece table 46. A meniscus 58 is formed at a periphery of the immersion area between the lower surface of the immersion fluid supply and recovery apparatus 50 and the upper surface of the work piece 30 and/or workpiece table 46. To prevent or at least reduce the amount of immersion liquid that has escaped from the immersion area from completely escaping from the environmental system 26, the environmental system 26 further includes an edge member 52. In the embodiment, the edge member 52 is mounted adjacent the immersion fluid supply and recovery apparatus 50. The edge member 52 is configured to extend past the lower surface of the immersion fluid supply and recovery apparatus 50 so that a lower portion of the edge member 52 is spaced at a second distance B, that is smaller than distance A, from the upper surface of the workpiece 30, the workpiece table 46, or both, at a position beyond the periphery of the immersion area. Because distance B between the edge member 52 and the upper surface of the workpiece 30 is smaller than distance A between the lower surface of the immersion fluid supply and recovery apparatus 50 and the upper surface of the workpiece 30, the edge member 52 reduces the area through which immersion liquid can escape from below the environmental system 26, for example, during movement of the workpiece 30, such as during long and fast moves of a workpiece stage 46 and/or during workpiece 30 exchanges, or if the immersion liquid has a low contact angle on the workpiece. That is, by reducing the distance from A to B, a lesser amount of immersion liquid is able to pass the outer edge of the immersion fluid supply and recovery apparatus 50.

In some embodiments, at least the lower portion of the edge member 52 is hydrophobic to repel the immersion liquid in a direction towards the immersion area. In other embodiments, at least a lower portion of the edge member 52 is hydrophilic so as to attract the immersion liquid that has escaped from the space 27. In some embodiments, the lower surface of the immersion fluid supply and recovery apparatus 50 includes a porous member 54. The porous member 54 can be a mesh, a porous material such as a sponge, or a member having etched holes therein. The porous member 54 can be, for example, glass, metal, ceramics or plastic. See, for example, U.S. 2007/0046910 A1, the disclosure of which is incorporated herein by reference in its entirety. A pore size of the pores in the porous member can be between about 5 μm and 175 μm. Smaller pore sizes are preferred because a smaller pore size increases the bubble point of the porous member 54, which, in turn, reduces the chances of gas being sucked through the porous member 54. Sucking gas through the porous member is not desirable because such gas can cause vibrations and temperature fluctuations, which adversely affects the image forming performance of the lithography apparatus.

The edge member 52 may be configured to guide immersion liquid escaping from the immersion area to the porous member 54. The porous member 54 is preferably disposed at the lower surface of the immersion fluid supply and recovery apparatus 50 so that immersion liquid that overflows or otherwise is separated from the immersion area and that is repelled or guided by the edge member 52 to the porous member 54 is easily absorbed by the porous member 54 from the upper surface of the workpiece 30, workpiece table 46, or both. The porous member 54 can be connected to a receptacle (not shown) for receiving the immersion liquid, and the receptacle can be communicated with a vacuum source (not shown), for example, to remove the immersion liquid from the porous member 54. Further, the environmental system 26 may include a recess 56 disposed at an outer periphery of the immersion fluid supply and recovery apparatus 50 to receive the immersion liquid guided from the edge member 52. Immersion liquid that accumulates in the recess 56 is absorbed by the porous member 54.

The edge member 52 may be made of any material suitable for reducing the escape of immersion liquid from the immersion area without interfering with workpiece processing. However, as a safety measure, the edge member 52 is preferably made of a flexible material so as not to damage the workpiece 30 or workpiece table 46 in case of accidental crashing of the workpiece 30 or workpiece table 46 with the edge member 52. In some embodiments, the edge member 52 is movably attached to the environmental system 26. For example, the edge member 52 may be pivotally attached to the environmental system 26 so as to pivot away from the workpiece 30 or workpiece table 46 to avoid accidental crashing with the workpiece 30 or workpiece table 46. In some embodiments, the edge member 52 is annular, and completely surrounds the immersion area.

Workpiece manufacturing methods include supplying and removing immersion liquid with an environmental system 26 to and from a space 27 including the gap between a workpiece 30 and an optical assembly 16 to form an immersion area. In the methods, the environmental system 26 has a lower surface disposed opposite from an upper surface of the workpiece 30, the workpiece table 48, or both, and the lower surface is spaced at a distance A from the workpiece 30, the workpiece table 46, or both, to form a meniscus 58 at a periphery of the immersion area. The methods further include inhibiting escape of immersion liquid from the environmental system by providing an edge member 52 that extends past the lower surface of the environmental system 26, so that a lower portion of the edge member 52 is spaced at a distance B, smaller than distance A, from the upper surface of the workpiece 30, the workpiece table 46, or both, at a position beyond the periphery of the immersion area. These methods may incorporate any of the embodiments discussed above, including combinations of the above embodiments.

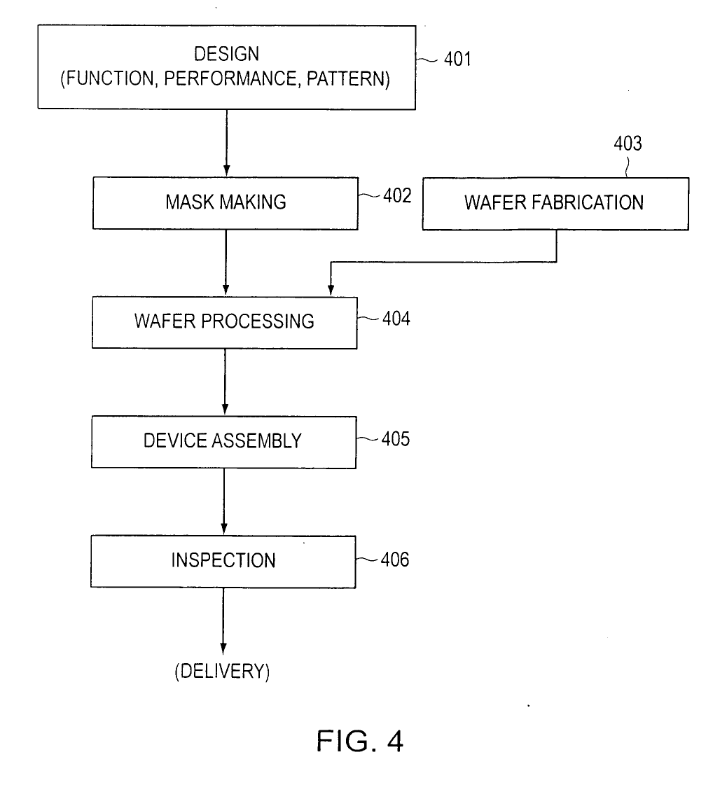

Workpieces, such as semiconductor wafers, can be fabricated using the above described systems, by the process shown generally in FIG. 4. In step 401 the substrate's function and performance characteristics are designed. Next, in step 402, a mask (reticle) having a pattern is designed according to the previous designing step, and in a parallel step 403 a workpiece is made from a silicon material. The mask pattern designed in step 402 is exposed onto the workpiece from step 403 in step 404 by a photolithography system described hereinabove in accordance with the various embodiments. In step 405 the workpiece is assembled (including the dicing process, bonding process and packaging process). Finally, the workpiece is then inspected in step 406.

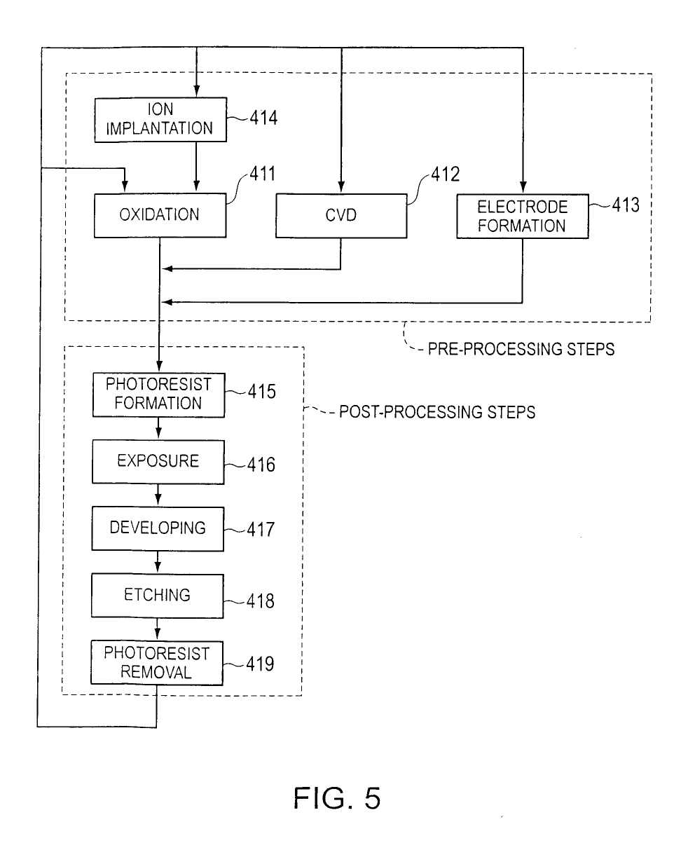

FIG. 5 illustrates a detailed flowchart example of the above-mentioned step 404 in the case of fabricating workpieces such as semiconductor substrates. In FIG. 5, in step 411 (oxidation step), the workpiece surface is oxidized. In step 412 (CVD step), an insulation film is formed on the workpiece surface. In step 413 (electrode formation step), electrodes are formed on the workpiece by vapor deposition. In step 414 (ion implantation step), ions are implanted in the workpiece. The above mentioned steps 411-414 form the preprocessing steps for workpieces during workpiece processing, and selection is made at each step according to processing requirements.

At each stage of workpiece processing, when the above-mentioned preprocessing steps have been completed, the following post-processing steps are implemented. During post-processing, first, in step 415 (photoresist formation step), photoresist is applied to a workpiece. Next, in step 416 (exposure step), the above-mentioned exposure substrate is used to transfer the circuit pattern of a mask (reticle) to a workpiece. Then in step 417 (developing step), the exposed workpiece is developed, and in step 418 (etching step), parts other than residual photoresist (exposed material surface) are removed by etching. In step 419 (photoresist removal step), unnecessary photoresist remaining after etching is removed.

Multiple circuit patterns are formed by repetition of these preprocessing and post-processing steps.

While the particular lithography apparatus as shown and disclosed herein are fully capable of obtaining the objects and providing the advantages herein before stated, it is to be understood that they are merely illustrative embodiments of the invention, and that the invention is not limited to these embodiments.

What is claimed is:

1. A lithographic projection apparatus comprising:
an optical assembly that projects an image onto a workpiece;
a stage assembly including a workpiece table that supports the workpiece adjacent to the optical assembly;
an environmental system that supplies and removes immersion liquid to and from a space between the workpiece and the optical assembly to form an immersion area, the environmental system having a lower surface disposed opposite from an upper surface of the workpiece, the workpiece table, or both, the lower surface spaced a first distance from the workpiece, the workpiece table, or both, to form a meniscus at a periphery of the immersion area; and
an edge member provided on the environmental system and extending past the lower surface of the environmental system so that a lower portion of the edge member is spaced a second distance, smaller than the first distance, from the upper surface of the workpiece, the workpiece table, or both, at a position beyond the periphery of the immersion area.

2. The apparatus of claim 1, wherein at least a portion of the edge member is hydrophobic.

3. The apparatus of claim 1, wherein at least a portion of the edge member is hydrophilic.

4. The apparatus of claim 1, wherein the lower surface of the environmental system includes a porous member, and the edge member guides to the porous member immersion liquid escaping from the immersion area.

5. The apparatus of claim 4, wherein the edge member is mounted adjacent a liquid recovery element of the environmental system.

6. The apparatus of claim 5, wherein the environmental system includes a recess disposed at an outer periphery of the liquid recovery element to receive the immersion liquid guided from the edge member.

7. The apparatus of claim 4, wherein a vacuum is applied to the porous member to remove the immersion liquid from the porous member.

8. The apparatus of claim 1, wherein the edge member is movably attached to the environmental system.

9. The apparatus of claim 8, wherein the edge member is pivotally attached to the environmental system.

10. The apparatus of claim 8, wherein the edge member is flexible.

11. The apparatus of claim 1, wherein the edge member is flexible.

12. The apparatus of claim 1, wherein the edge member is annular and surrounds the immersion area.

13. A workpiece manufacturing method comprising:
supplying and removing immersion liquid with an environmental system to and from a space between a workpiece and an optical assembly to form an immersion area, the environmental system having a lower surface disposed opposite from an upper surface of the workpiece, the workpiece table, or both, the lower surface spaced a first distance from the workpiece, the workpiece table, or both, to form a meniscus at a periphery of the immersion area; and
inhibiting escape of immersion liquid from the environmental system by providing an edge member that extends past the lower surface of the environmental system, so that a lower portion of the edge member is spaced a second distance, smaller than the first distance, from the upper surface of the workpiece, the workpiece table, or both, at a position beyond the periphery of the immersion area.

14. The method of claim 13, wherein:
a porous member is disposed at the lower surface of the environmental system; and
the edge member guides to the porous member immersion liquid escaping from the immersion area.

15. The method of claim 14, wherein:
the edge member is disposed adjacent a liquid recovery element of the environmental system.

16. The method of claim 15, wherein:
a recess is provided at an outer periphery of the liquid recovery element to receive the immersion liquid guided to the porous member by the edge member.

17. The method of claim 14, further comprising:
applying a vacuum to the porous member to remove the immersion liquid from the porous member.

18. The method of claim 13, wherein:
the edge member is movably attached to the environmental system.

19. The method of claim 18, wherein:
the edge member is pivotally attached to the environmental system.

20. The method of claim 13, wherein the edge member is annular and surrounds the immersion area.
